(19) United States
(12) Patent Application Publication
(10) Pub. No.: US 2011/0276329 A1
(43) Pub. Date: Nov. 10, 2011

(54) SPEECH DIALOGUE APPARATUS, DIALOGUE CONTROL METHOD, AND DIALOGUE CONTROL PROGRAM

(76) Inventors: Masaaki Ayabe, Tokyo (JP); Jun Okamoto, Tokyo (JP)

(21) Appl. No.: 13/145,147

(22) PCT Filed: Jan. 20, 2010
(86) PCT No.: PCT/JP2010/050631

§ 371 Date: Jul. 19, 2011

(30) Foreign Application Priority Data
Jan. 20, 2009 (JP) 2009-009964

(51) Int. Cl. G10L 15/06

(52) U.S. Cl. 704/243; 704/E15.007

(57) ABSTRACT

A speech dialogue apparatus, a dialogue control method, and a dialogue control program are provided, whereby an appropriate dialogue control is enabled by determining a user's proficiency level in a dialogue behavior correctly and performing an appropriate dialogue control according to the user's proficiency level correctly determined, without being influenced by an accidental one-time behavior of the user. An input unit 1 inputs a speech uttered by the user. An extraction unit 3 extracts a proficiency level determination factor that is a factor for determining a user's proficiency level in a dialogue behavior, based upon an input result of the speech of the input unit 1. A history storage unit 4 stores as a history the proficiency level determination factor extracted by the extraction unit 3. A proficiency level determination unit 5 determines a convergence state of the proficiency level determination factor based upon the history stored in the history storage unit 4, and for determining the user's proficiency level in the dialogue behavior based upon the convergence state determined. A dialogue control unit 6 changes the dialogue control according to the user's proficiency level determined by the proficiency level determination unit 5.

### TECHNICAL FIELD

The present invention relates to a speech dialogue apparatus for use in a system that performs processing based on a speech recognition result of a dialogue with a user, a dialogue control method, and a dialogue control program.

### BACKGROUND ART

A conventional speech dialogue apparatus for use in a communication with a user is provided with, for example, input request means for outputting a signal requesting a speech input, recognition means for recognizing the speech input, measurement means for measuring a period between the time when the speech input is requested and the time when the speech input is detected or a duration time of the speech input (utterance period), and output means for outputting a speech response signal corresponding to the speech recognition result.

In order to give each user an appropriate response based upon a response time or a speech input time of each user, some of such speech dialogue apparatus make a variable control of the period between the time when the speech input is detected and the time when the speech response signal is output, the response time of the speech response signal, or the form of representation of the speech response signal, based upon the period from the time when the speech input is requested to the time when the speech input is detected or the duration time of the speech input. As an example, in Patent Document 1, the user's proficiency level is estimated by use of the appearance time of a keyword in the user's speech, the number of syllables of a keyword, the keyword utterance duration time, or the like, to control the dialogue response according to the user's proficiency level.

### PRIOR ART DOCUMENTS

### Patent Documents

Patent Document 1: JP 2005-234331 A

### SUMMARY OF THE INVENTION

### Problem to be Solved

It is to be noted that, however, according to the technique disclosed in Patent Document 1, the user's proficiency level is determined by use of only information on one-time dialogue between the user and the speech dialogue apparatus. For this reason, it is not possible to determine the user's proficiency level correctly, in a case where the user is able to communicate with the speech dialogue apparatus well by chance, although the user does not sufficiently master the speech dialogue apparatus, or conversely, in a case where the user is not able to communicate with the speech dialogue apparatus well, although the user masters the speech dialogue apparatus. This is accompanied by a problem that the dialogue control cannot be made in an appropriate manner. An example is that when the user is not able to make dialogue well unexpectedly even if the user masters how to do in the dialogue with the speech dialogue apparatus, an audio guidance is repeatedly output in some cases. Therefore, the user is not able to make a speech dialogue smoothly.

The present invention has been made in view of the above-described conventional problem, and provides a speech dialogue apparatus, a dialogue control method, and a dialogue control program, whereby a user's proficiency level in the dialogue behavior is determined correctly without being influenced by the user's accidental one-time dialogue behavior, and an appropriate dialogue control is enabled according to the user's proficiency level correctly determined.

### Solution to the Problem

In order to solve the above problem, there is provided a speech dialogue apparatus, as recited in claim 1, for recognizing a speech uttered by a user and for performing a dialogue control, the speech dialogue apparatus comprising: an input unit for inputting the speech uttered by the user; an extraction unit for extracting a proficiency level determination factor that is a factor for determining a user's proficiency level in a dialogue behavior, based upon an input result of the speech of the input unit; a history storage unit for storing a history the proficiency level determination factor extracted by the extraction unit; a proficiency level determination unit for determining a convergence state of the proficiency level determination factor based upon the history stored in the history storage unit, and for determining the user's proficiency level in the dialogue behavior based upon the convergence state determined; and a dialogue control unit for changing the dialogue control according to the user's proficiency level determined by the proficiency level determination unit.

According to the present invention, the speech dialogue apparatus determines the convergence state of the proficiency level determination factor based upon the history stored in the history storage unit, determines the user's proficiency level in the dialogue behavior based upon the convergence state determined, and changes the dialogue control based upon the user's proficiency level determined. It is therefore possible to perform the dialogue control in an appropriate manner according to the proficiency level correctly determined, rather than a case where the user's proficiency level is determined based upon the user's one-time dialogue behavior.

In the speech dialogue apparatus according to claim 1, as recited in claim 2, the proficiency level determination factor may be an utterance timing. According to the present invention, the utterance timing is used as the proficiency level determination factor that is a representative factor of easily improving the user's proficiency level and making an influence on the speech recognition. It is therefore possible to prevent an unnecessary dialogue control for a user who has already mastered the utterance timing.

In the speech dialogue apparatus according to claim 1, as recited in claim 3, the proficiency level determination factor may include at least one of an utterance style of the user, a speech content factor that is an index of whether or not the user understands a content to be spoken, and a pose period. In the speech dialogue apparatus according to claim 3, as recited in claim 4, the input unit may comprise an utterance start unit for interrupting the dialogue control unit when the dialogue control unit detects an interrupt operation of current control, and for starting a speech input, and the speech content factor includes the number of interruption times in the dialogue control. According to the present invention, it is possible to determine the user's proficiency level in terms of the speech content by the convergence state of the number of interruptions in the dialogue control based upon the history.

In the speech dialogue apparatus according to any one of claim 1 to claim 4, as recited in claim 5, the dialogue control unit may enhance the dialogue control in a case where the proficiency level determination unit determines that the user's proficiency level in the dialogue behavior is low, rather than in a case where the proficiency level determination unit determines that the user's proficiency level in the dialogue behavior is high. According to the present invention, the dialogue control unit is capable of performing the dialogue control according to the user's proficiency level in the dialogue behavior correctly determined based upon the history, without being influenced by an accidental one-time dialogue behavior of the user.

According to another aspect of the present invention, as recited in claim 6, there is provided a dialogue control method for recognizing a speech uttered by a user and for performing a dialogue control, the dialogue control method comprising: inputting the speech uttered by the user; extracting a proficiency level determination factor that is a factor for determining a user's proficiency level in a dialogue behavior, based upon an input result of the speech of the inputting; storing a history the proficiency level determination factor extracted by the extracting; determining a convergence state of the proficiency level determination factor based upon the history stored in the storing and for determining the user's proficiency level in the dialogue behavior based upon the convergence state determined; and changing the dialogue control according to the user's proficiency level determined in the determining.

According to another aspect of the present invention, as recited in claim 7, there is provided a dialogue control program for causing a computer to execute a process comprising: inputting the speech uttered by the user; extracting a proficiency level determination factor that is a factor for determining a user's proficiency level in a dialogue behavior, based upon an input result of the speech of the inputting; storing a history the proficiency level determination factor extracted by the extracting; determining a convergence state of the proficiency level determination factor based upon the history stored in the storing and for determining the user's proficiency level in the dialogue behavior based upon the convergence state determined; and changing the dialogue control according to the user's proficiency level determined in the determining. According to the present invention, the dialogue control program is stored in a memory device provided in the computer, so that the computer reads out and executes the program, whereby each of the above steps is performed.

### ADVANTAGEOUS EFFECTS OF THE INVENTION

According to the present invention, the speech dialogue apparatus determines the convergence state of the proficiency level determination factor based upon the history stored in the history storage unit, determines the user's proficiency level in the dialogue behavior based upon the convergence state determined, and changes the dialogue control based upon the user's proficiency level determined.

### BRIEF DESCRIPTION OF THE DRAWINGS

FIG. 1 is a block diagram illustrative of a functional configuration of a speech dialogue apparatus according to an embodiment of the present invention;

FIG. 2 is a graph illustrative of a relationship between an utterance timing measured whenever each test subject utters a speech and a speech recognition result, according to the embodiment;

FIG. 3 is a graph illustrative of a relationship between an utterance timing measured whenever each test subject utters a speech and a speech recognition result, according to the embodiment;

FIG. 4 is a graph illustrative of changes in recognition error rates by age groups, before and after the utterance timings are converged, according to the embodiment;

FIG. 5 is a flowchart illustrative of a flow of a dialogue control process in a case where an utterance timing is a proficiency level determination factor, according to the embodiment;

FIG. 6 is a flowchart illustrative of a flow of a dialogue control process in a case where an utterance speed among utterance styles is the proficiency level determination factor, according to the embodiment;

FIG. 7 is a diagram illustrative of an example for an utterance period per utterance of the user, according to the embodiment;

FIG. 8 is a graph illustrative of a history of the utterance periods measured by the extraction unit, according to the embodiment;

FIG. 9 is a graph illustrative of a history of the number of pronunciations recognized by a speech recognition unit, according to the embodiment;

FIG. 10 is a graph illustrative of an example of a history of unit utterance period calculated by an utterance period and the number of pronunciations, according to the embodiment;

FIG. 11 is a graph illustrative of an example of a change amount in the utterance periods calculated from the history of unit utterance period, according to the embodiment;

FIG. 12 is a flowchart illustrative of a flow of a dialogue control process in a case where a proficiency level determination factor is a speech content factor, according to the embodiment; and

FIG. 13 is a graph illustrative of an example of a dialogue control interruption history, according to the embodiment.

### DESCRIPTION OF EMBODIMENTS

Hereinafter, embodiments of the present invention will be described with reference to the accompanied drawings.

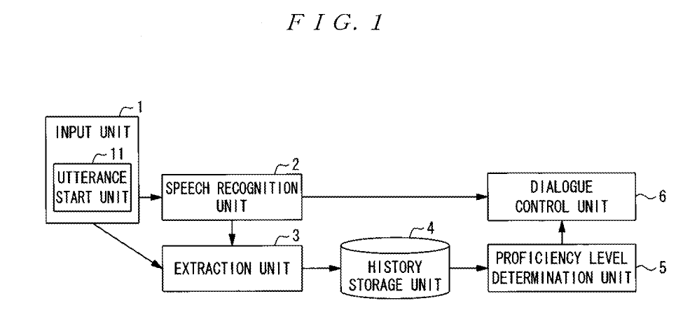

FIG. 1 is a block diagram illustrative of a functional configuration of a speech dialogue apparatus according to an embodiment of the present invention. These functions are implemented by a Central Processing Unit (CPU), a Read Only Memory (ROM) in which programs and data are stored, a memory device such as a hard disk, an internal clock, a microphone, an operational button, and an input/output interface such as a speaker, all of which are not illustrated and provided in the speech dialogue apparatus to operate in cooperation with each other.

An input unit 1 includes a microphone or an operational button to input a speech uttered by a user or an operational signal for a speech input. The input unit 1 is provided with an utterance start unit 11 for interrupting a dialogue control of outputting an audio guidance or the like and starting to input a speech uttered by a user. The utterance start unit 11 includes a button of giving an instruction of interrupting the dialogue control to the CPU of the speech dialogue apparatus.

The input of the speech uttered by the user includes the following one.

### Communication Example

System: “Please select your request from words on the buttons”
User: “Make a phone call”
System: “Recognition was failed. The input word may be one that this device does not know, so it may have been input incorrectly. Alternatively, your voice may be too loud, your speaking speed may be too fast, or oppositely your speaking speed may be too slow. Please say it at a normal speed once again”.

### User: “Telephone”

System: “Telephone screen is displayed”
User: “Go back”
System: “Where are you returning? Choose one from the following two. If you cancel the last operation, please speak ‘Cancel’. When you return to the previous menu, please speak ‘Go back to the previous menu’”.
User: “Go back to the previous menu”
System: “Going back to the previous menu”

A speech recognition unit 2 performs a recognition process of a speech input by the input unit 1, by use of a known algorithm like a Hidden Markov Model or the like. In addition, the speech recognition unit 2 outputs a content of the recognized speech as character strings, for example, phonemic symbol strings, mora code (Kana character) strings or the like. An extraction unit 3 extracts a proficiency level determination factor to be a factor of determining the user's proficiency level in the dialogue behavior, based upon an input result of the input unit 1. The proficiency level determination factor includes an utterance timing, an utterance style, a speech content factor to be an index of whether or not the user understands the content to be spoken, and a pose period.

The utterance timing is a timing when the user utters a speech, when the speech dialogue apparatus gives a sign of requesting the user to input the speech by making a beep sound or an audio guidance “Please say”. The utterance timing is available by measuring an elapsed time from the time when the speech dialogue apparatus finishes giving the sign of requesting the user to input a speech to the time when the user starts an utterance (hereinafter, referred to as “utterance start period”). If the utterance timing is incorrect in the case where the user starts an utterance while the speech dialogue apparatus is giving the sign, the speech recognition unit 2 of the speech dialogue apparatus is not capable of recognizing the content of the user's speech.

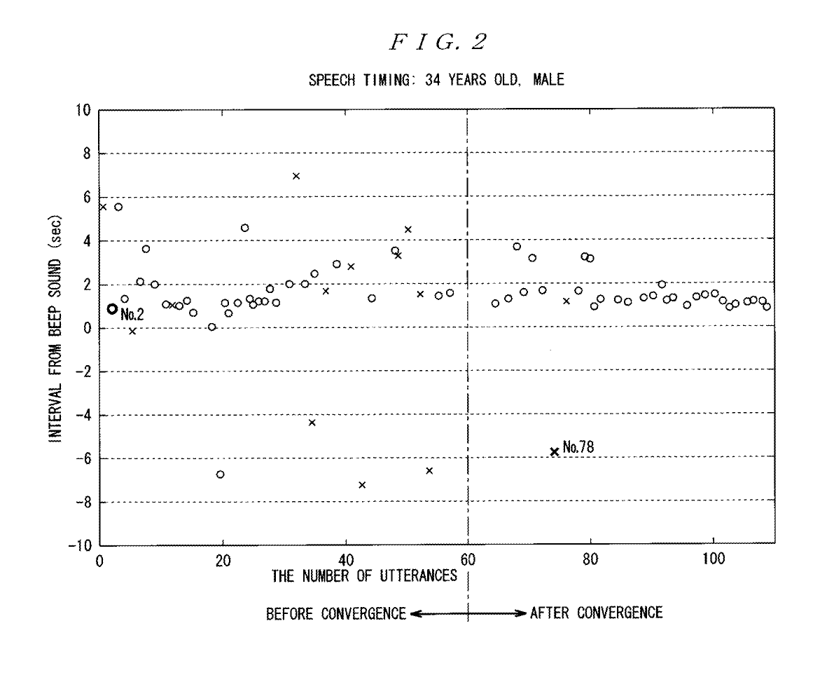

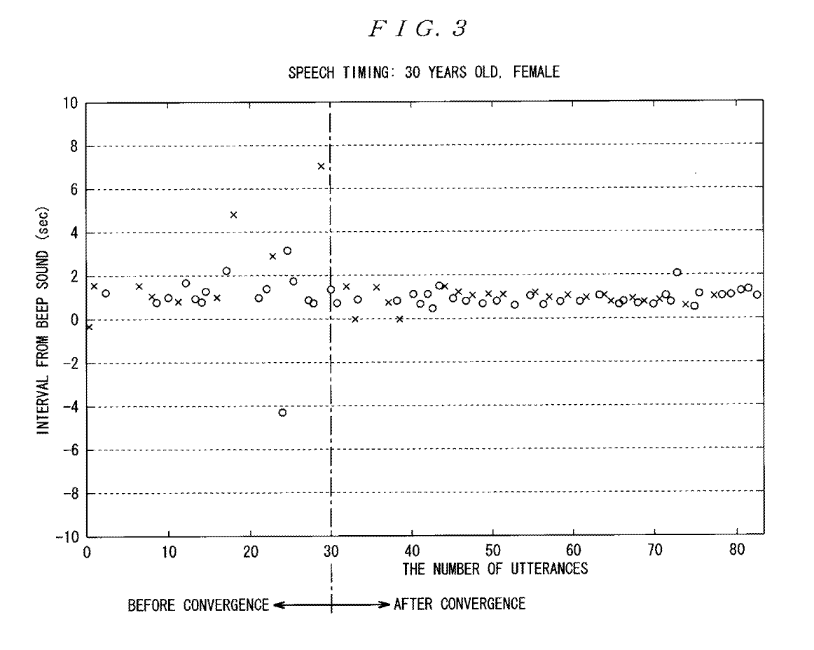

Graphs illustrated in FIG. 2 and FIG. 3 are illustrative of relationships between utterance timings measured whenever each test subject utters and speech recognition results. The vertical axis represents the elapsed time from the time when the sign is given by a beep sound to the time when the user utters, and the horizontal axis represents how many times the user has uttered since the user started using the speech dialogue apparatus. In the figures, circle-marks indicate that a correct recognition result was obtained for the speech, whereas x-marks indicate that incorrect recognition result was obtained for the speech. The incorrect recognition result means that the speech recognition unit 2 outputs a result different from the content of the user's speech. The graph illustrated in FIG. 2 exhibits that, the utterance timings are varied and are not converged and the frequency of occurrence of x-marks each being the incorrect recognition is high when the number of utterances is small. However, as the test subject becomes to master the utterance timing when the number of utterances exceeds 60 times, the utterance timings are converged, and in addition, the frequency of occurrence of x-marks each being the incorrect recognition is decreased.

In the graph illustrated in FIG. 3, the test subject masters the utterance timing at the thirtieth utterance or so, and the utterance timings are converged. While the utterance timings have been converged, no change in the utterance timing occurs even if the incorrect recognition occurs.

For instance, when the user's proficiency level is determined at a prescribed number of utterances, if the user's utterance timing does not satisfy the criteria (an example is that the utterance start period should fall within a prescribed period) even just once, it is determined that the user's proficiency level is not sufficient. In detail, as to the seventy-eighth utterance in FIG. 2 (see No. 78), since the utterance timing is diverged to a great degree, it is determined that the user's proficiency level is not sufficient. On the contrary, although the user has not mastered the device but the utterance timing satisfies the determination standard by chance, it is determined that the user's proficiency level is sufficient. In detail, as to the second speech in FIG. 2 (see No. 2), since the utterance timing is not diverged, it is determined that the user's proficiency level is sufficient.

Now, by use of the test results exhibited in FIG. 2 and FIG. 3, a more detailed description will be given of the difference in the recognition rate between a case where the user's proficiency level is determined by a prescribed number of utterances and a case where the user's proficiency level is determined based upon the convergence state of the utterance timings according to the present invention.

Firstly, in the case where the user's proficiency level is determined by a prescribed number of utterances, the inventors of the present invention have calculated the recognition rate before mastering the device and that after mastering the device, with the number of proficiency level determination times (the number of utterances at which the user's proficiency level is determined to be sufficient) being 30 times as the prescribed number of utterances, based upon the test results of FIG. 2 and FIG. 3. This results in that the recognition rate of the test subjects of FIG. 2 (hereinafter, referred to as “test subject 1” in the description herein) before mastering the device is 87.5% and that after mastering the device is 78.0%. This also results in that the recognition rate of the test subjects of FIG. 3 (hereinafter, referred to as “test subject 2” in the description herein) before mastering the device is 56.25% and that after mastering the device is 63.83%. That is to say, the test subject 1 has a lower recognition rate after mastering the device, but the test subject 2 has a higher recognition rate in mastering the device. According to these results, the relationships between the number of proficiency level determination times and the recognition rates are completely different between the test subject 1 and the test subject 2.

In the case where the user's proficiency level is determined based upon the convergence state of the utterance timings, the number of proficiency level determination times are considered to be 60 times in FIG. 2 and 30 times in FIG. 3. In such cases, as to the test subject 1, the recognition rate before mastering the device is 71.43% and the recognition rate after mastering the device is 93.75%. Additionally, as to the test subject 2, the recognition rate before mastering the device is 56.25% and the recognition rate after mastering the device is 63.83%. That is to say, the results of both of the test subject 1 and the test subject 2 are higher in the recognition rate after mastering the device. According to the above results, both of the test subject 1 and the test subject 2 exhibit the same tendency in the relationship between the convergence state and the recognition rate. Although the detailed description is omitted herein, the same tendency has been obtained in other test subjects.

The utterance style means an utterance manner such as loudness of speeches, utterance speed, flowing eloquence, and the like. Unless a user does not have a good utterance style, the speech dialogue apparatus misrecognizes the content of the user's speech. The content of the user's speech means a content to be input by the user into the speech dialogue apparatus so that the user achieves the purpose. If the content of speech is misrecognized, the user is not able to operate the speech dialogue apparatus as the user's intention. As the speech content factor to be an index of whether or not the user understands the content to be spoken, there is the number of dialogue control times interrupted by the utterance start unit 11. The pose period means that a silent period existent, while the user is uttering a speech. For example, when uttering an address, some users may pose for a small amount of time between prefecture and city or town name. This pose period means such a small amount of time.

The improvement of the user's proficiency level has a sequential order, and the inventors of the present invention believe that the improvements are made in the utterance timing, utterance style, and speech content, in this order. Accordingly, the utterance timing is firstly extracted as the proficiency level determination factor, the utterance style is extracted after the user masters the utterance timing, and the speech content is extracted after the user masters the utterance style. In this manner, the speech content factor to be extracted can be changed in stages according to the user's proficiency level.

A history storage unit 4 is a database provided in a memory device such as a hard disk or the like, and stores the proficiency level determination factors extracted by the extraction unit 3. A proficiency level determination unit 5 determines the convergence state of the proficiency level determination factors based upon the history stored in the history storage unit 4, and determines the user's proficiency level in the dialogue behavior based upon the determined convergence state. When plural users commonly use the speech dialogue apparatus, user IDs are provided for identifying users, respectively, so that the proficiency level determination factors are stored by the respective user IDs in the history storage unit 4. Then, the proficiency level determination unit 5 determines the convergence state of the proficiency level determination factors based upon the history stored by each user, and then determines the user's proficiency level of the dialogue behavior of the user who is currently using the speech dialogue apparatus. As a method of inputting the current user into the speech dialogue apparatus, for example, the user may input the user's name into the speech dialogue apparatus by himself/herself, or the speech dialogue apparatus may further be provided with a speaker identification unit by use of speech or an Radio Frequency (RF) tag identification information obtaining unit for obtaining identification information of an RF tag owned by the user.

Specifically, in a case where the proficiency level determination factor is the utterance timing, the proficiency level determination unit 5 determines, for example, whether or not a certain number of utterance start timings in the history stored in the history storage unit 4 are converged into a prescribed timing. When they are converged, it is determined that the user has a high proficiency level in the utterance timing, whereas when they are not, it is determined that the user has a low proficiency level in the utterance timing. An example is that whether or not the utterance start timings of the most recent ten speeches are converged into within one second is checked.

When they are converged into within one second, it is determined that the user has a high proficiency level in the utterance timing, whereas when they are not, it is determined that the user has a low proficiency level in the utterance timing. The prescribed timing to be converged into is not limited to one second, and may be set individually for each user in association with the user ID.

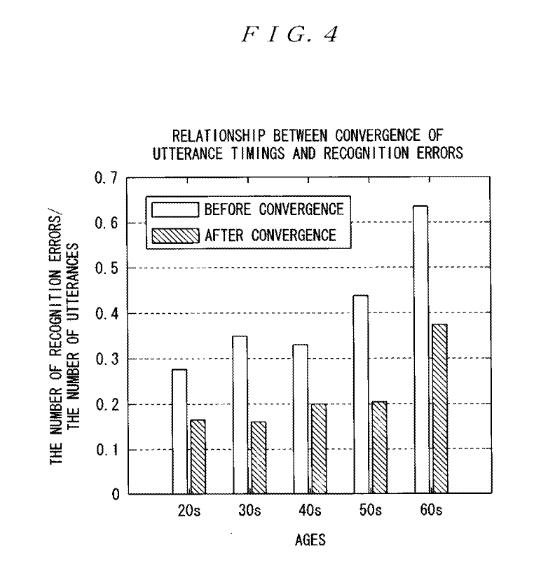

FIG. 4 is a graph illustrative of the recognition rates by age groups, determined by the utterance timing, before and after users master the device. The recognition rate denotes the rate of the user's speech correctly recognized by the speech recognition unit 2. Before convergence denotes a period while the proficiency level determination unit 5 is determining that the user's proficiency level of the utterance timing is low, whereas after convergence means a period while the proficiency level determination unit 5 is determining that the user's proficiency level of the utterance timing is high.

As illustrated in FIG. 4, there are differences in the recognition error rate (=the number of recognition error times/the number of utterances) between the respective age groups. However, the recognition error rates are reduced in common among the respective age groups after the convergence rather than before the convergence.

In a case where the proficiency level determination factor is the utterance style, the proficiency level determination unit 5 determines the convergence state of the loudness of voice, utterance speed or the like. When the utterance style is converged, it is determined that the user's proficiency level of the utterance style is high. In a case where the proficiency level determination factor is the speech content factor, the proficiency level determination unit 5 determines whether a certain rate or more of the prescribed dialogue controls have been interrupted among a certain number of the prescribed dialogue control times in the past. When a certain rate or more of the prescribed dialogue controls have been interrupted, it is determined that the user's proficiency level of the speech content is high.

A dialogue control unit 6 changes the dialogue control according to the user's proficiency level determined by the proficiency level determination unit 5. In detail, the dialogue control unit 6 enhances the dialogue control in the case where the proficiency level determination unit 5 determines that the user's proficiency level of the dialogue behavior is low. The dialogue control unit 6 repeats the audio guidance, for example. On the other hand, in the case where the proficiency level determination unit 5 determines that the user's proficiency level of the dialogue behavior is high, the dialogue control unit 6 suppresses the dialogue control. The dialogue control unit 6 does not output the audio guidance even if a recognition error occurs, or the frequency of outputting the audio guidance is made lower than that of the case where the user's proficiency level is determined to be low.

### (Utterance Timing)

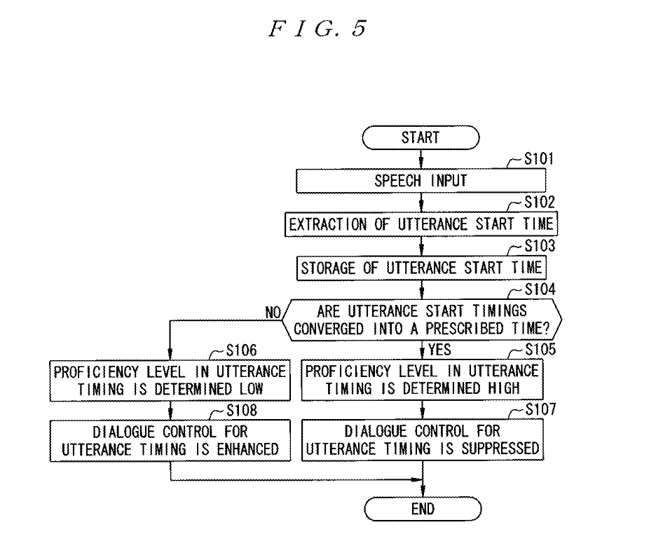

Next, with reference to the flowchart of FIG. 5, a dialogue control process in the case where the proficiency level determination factor is the utterance timing will be described. Firstly, a user utters toward the speech dialogue apparatus after the speech dialogue apparatus outputs a sign of a speech input start. The input unit 1 of the speech dialogue apparatus inputs the speech uttered by the user (step S101). The extraction unit 3 determines the time when the speech input from the input unit 1 starts, and extracts the utterance start period from the when the speech dialogue apparatus outputs the sing of requesting the user of the speech input to the time when the user starts uttering (step S102). The history storage unit 4 stores the utterance start period extracted by the extraction unit 3 (step S103).

The proficiency level determination unit 5 refers to the utterance start period stored in the history storage unit 4 to determine whether or not the user's utterance start timings of a prescribed number of utterances are converged into a prescribed time (step S104). When they are converged (step S104: YES), the user's proficiency level of the utterance timing is determined to be high (step S105). When they are not converged (step S104: NO), the user's proficiency level of the utterance timing is determined to be low (step S106).

The dialogue control unit 6 changes the dialogue control according to the user's proficiency level of the user's utterance timing obtained by the proficiency level determination unit 5. For instance, when the user's proficiency level of the utterance timing is low, the guidance for the utterance timing is made to output more frequently (step S108). When the user's proficiency level of the utterance timing is high, the guidance for the utterance timing is made to output less frequently (step S107).

### (Utterance Style)

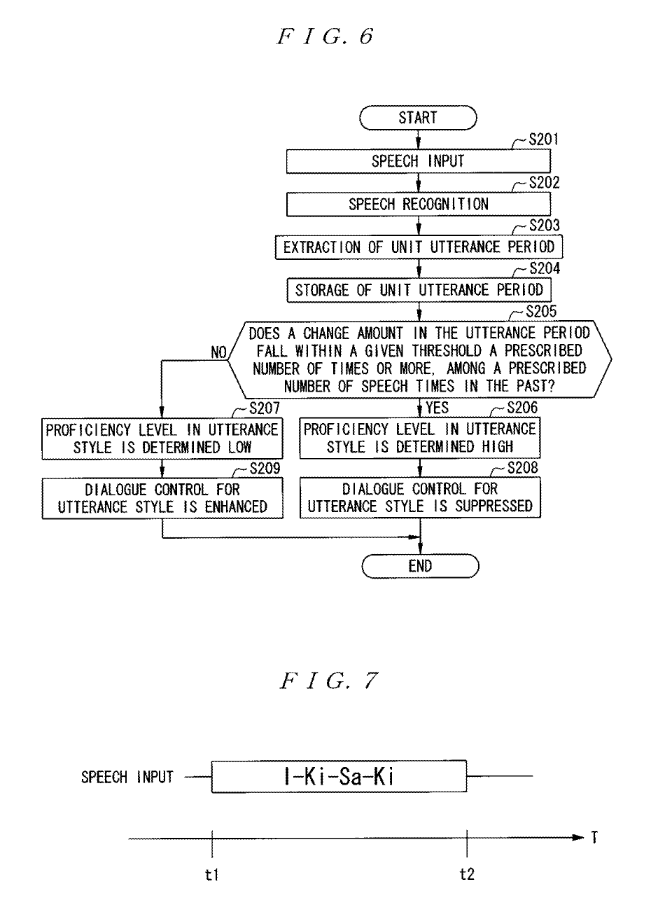

Next, with reference to the flowchart of FIG. 6, a dialogue control process in a case where the proficiency level determination factor is the utterance speed in the utterance style. The input unit 1 inputs a speech uttered by a user (step S201). The speech recognition unit 2 recognizes the user's speech input from the input unit 1 (step S202), and outputs a content of the speech recognized, as character strings.

The extraction unit 3 measures the period of a section in which the user utters each time (utterance period), and in addition, counts the number of pronunciations of the character strings obtained by the speech recognition unit 2 to measure the utterance period for each pronunciation (hereinafter, referred to as “unit utterance period”). The number of pronunciations denotes the number of phonemes or moras obtained by the speech recognition unit 2 based upon the speech uttered by the user each time, or denotes the total number of both of the phonemes and moras that are mixed. The extraction unit 3 outputs the unit utterance period of the user's speech each time (step S203). The history storage unit 4 stores the unit utterance period obtained by the extraction unit 3 (step S204).

The proficiency level determination unit 5 refers to the histories of the unit utterance periods stored in the history storage unit 4, gets the difference between the unit utterance period per utterance and its most recent unit utterance period, and calculate a change amount in the utterance period that is an absolute value in the change of the unit utterance period. When such a change amount in the utterance period is equal to or greater than a given threshold a prescribed number of times or more among a prescribed number of utterances in the past (step S205: NO), the change amounts in the utterance period are not converged and the user's proficiency level is determined to be low (step S207). In contrast, when such a change amount in the unit utterance period falls within a given threshold a prescribed number of times or more among a prescribed number of utterances in the past (step S205: YES), the change amounts in the utterance period are converged and the user's proficiency level is determined to be high (step S206). The dialogue control unit 6 delivers a guidance in relation to the utterance style, when the user's proficiency level is determined to be low based upon the determination result of the user's proficiency level of the utterance style obtained by the proficiency level determination unit 5 (step S209). The dialogue control unit 6 does not deliver a guidance in relation to the utterance style, when the user's proficiency level is determined to be high (step S208).

Referring now to FIG. 6 to FIG. 11, a specific example of a proficiency level determination method in relation to the utterance style will be described. It is assumed that the user utters a speech “I-Ki-Sa-Ki”. Then, the extraction unit 3 measures the utterance period of each time from the time when the user starts an utterance (t1 of FIG. 7) to the time when the user finishes uttering the speech (t2 of FIG. 7) (step S203 of FIG. 6). The extraction unit 3 also obtains “four” as the number of pronunciations (syllables) of “I-Ki-Sa-Ki” from the character strings “I-Ki-Sa-Ki” that is the result recognized by the speech recognition unit 2 (step S202). After that, the extraction unit 3 calculates the unit utterance period necessary for the user to utter each pronunciation, and stores it in the history storage unit 4 (step S204).

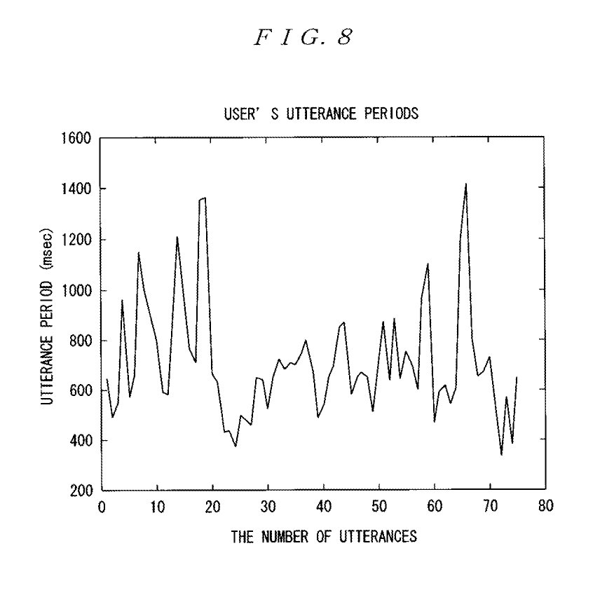

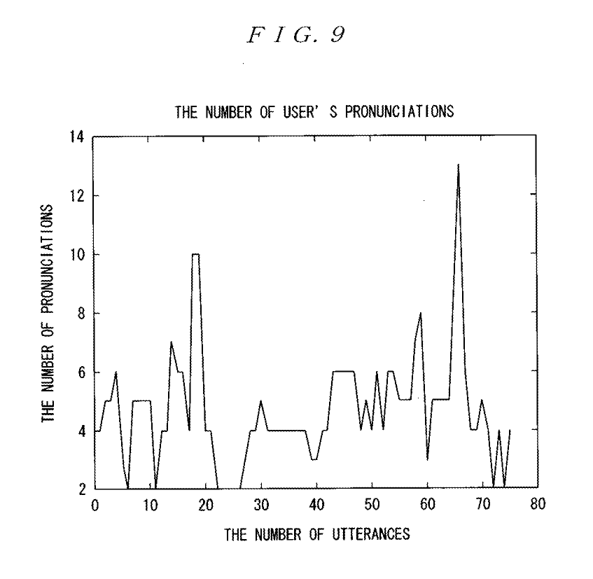

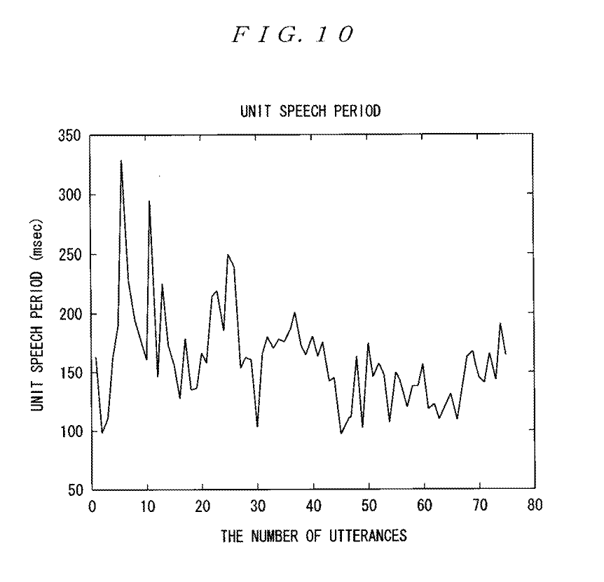

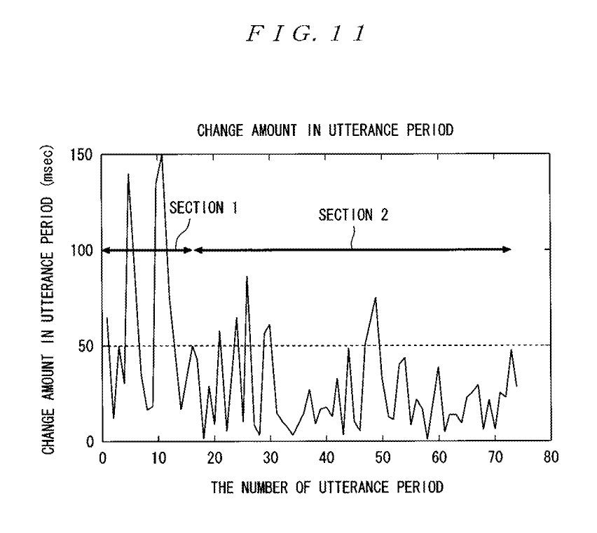

FIG. 8 is a graph illustrative of a history of the utterance periods measured by the extraction unit 3 whenever the user utters a speech. FIG. 9 is a graph illustrative of a history of the number of pronunciations recognized by the speech recognition unit 2 whenever the user utters a speech. FIG. 10 is a graph illustrative of a history of the unit utterance period, whenever the user utters a speech, calculated by the utterance period illustrated in FIG. 8 and the number of pronunciations illustrated in FIG. 9. Such unit utterance periods are stored in the history storage unit 4. The proficiency level determination unit 5 refers to the history of the user's unit utterance periods stored in the history storage unit 4, and calculates the change amount in the utterance period (step S205). FIG. 11 illustrates an example of the change amount in the utterance period calculated.

For example, in a case where there is a change amount in the utterance period that exceeds a prescribed threshold five times among ten times (step S205: NO), the user's proficiency level is determined to be low (step S207). In a case where there is a change amount in the utterance period that is lower than a prescribed threshold five times among ten times (step S205: YES), the user's proficiency level is determined to be high (step S206). A section 1 illustrated in FIG. 11 represents the section where the user's proficiency level is determined to be low, and a section 2 represents the section where the user's proficiency level is determined to be high. Then, the dialogue control unit 6 repeats the guidance in relation to the utterance style in the section 1 (step S209), but changes the behavior not to deliver the guidance in the section 2 (step S208).

### (Speech Content)

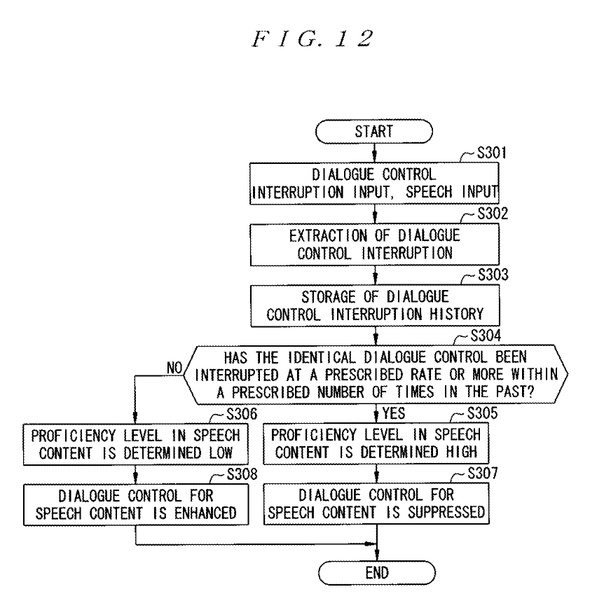

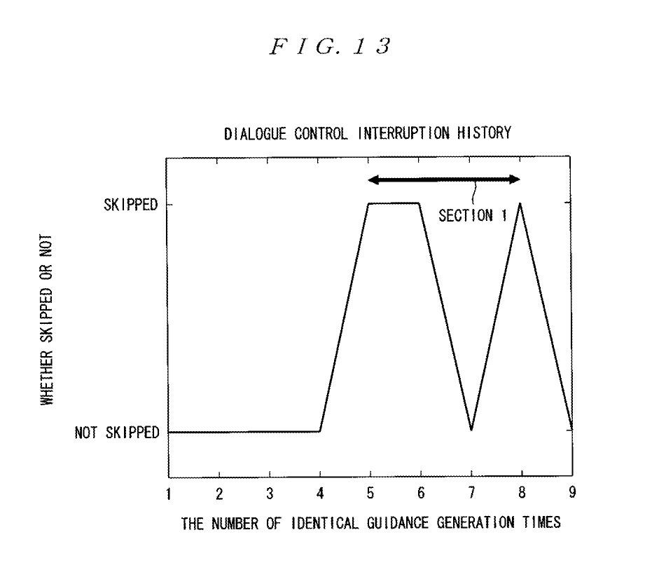

Next, with reference to the flowchart of FIG. 12, the dialogue control process in a case where the proficiency level determination factor is the speech content factor will be described. When a user interrupts the dialogue control to input a speech while the dialogue control unit 6 is performing the dialogue control of outputting the audio guidance or the like, the user uses the utterance start unit 11 to give an instruction of interrupting the dialogue control. This causes the utterance start unit 11 to interrupt the dialogue control of the dialogue control unit 6, and the input unit 1 inputs a speech uttered by the user (step S301). The extraction unit 3 extracts the number of dialogue control interruption times based upon the input result of the speech or the dialogue control interruption operation (step S302). The history storage unit 4 stores the number of dialogue control interruption times (step S303).

The proficiency level determination unit 5 refers to the history storage unit 4 to determine whether the dialogue control in relation to a certain speech content has been interrupted at a prescribed rate or more within a prescribed number of times in the past (step S304). When the dialogue control has been interrupted (step S304: YES), the user's proficiency level in the speech content is determined to be high (step S305). When the dialogue control has not been interrupted (step S304: NO), the user's proficiency level in the speech content is determined to be low (step S306).

The dialogue control unit 6 changes the dialogue control according to the user's proficiency level of the speech content determined by the proficiency level determination unit 5. Specifically, when the user's proficiency level of the speech content is determined to be high, the audio guidance in relation to the speech content is delivered less frequently (step S307). When the user's proficiency level of the speech content is determined to be low, the audio guidance in relation to the speech content is delivered more frequently (step S308). A specific example of the speech content will be described here. The following is an example of dialogue for interrupting (skipping) the guidance by use of the utterance start unit 11 to start the speech.

User's speech: “Address”
Guidance: “Recognition was failed. When editing data, encircled editing area . . . ”
(Beep Sound Made by User's Guidance Interruption Operation) User's speech: “Address”

In the above dialogue, the content uttered by the user cannot be recognized by the speech dialogue apparatus and the guidance of an instruction of what can be input next is starting to be delivered. However, the user operates to interrupt the guidance and makes a speech input of the same content again soon (step S301 of FIG. 12). The extraction unit 3 discovers such a usage of the utterance start unit 11 (step S302). Then, the history storage unit 4 stores information indicating that such dialogue control interruption has been done (step S303). The proficiency level determination unit 5 refers to the histories of the dialogue control interruption in relation to the guidance of giving, from the history storage unit 4, an instruction of a certain speech content, and determines the convergence state of the dialogue control interruption times to obtain the user's proficiency level. FIG. 13 illustrates a history that a user has skipped the dialogue control for the guidance of the content “Select your request from words on the buttons, and talk”. The user listens to the guidance “Select your request from words on the buttons, and talk” to the end from the first to the fourth times, and the user utters a subsequent speech.

Since then, the user often skips the guidance by use of the utterance start unit 11. In this situation, the proficiency level determination unit 5 refers to the history of three dialogue control interruptions of the identical guidance in the past. When the interruption was made at least twice among the three interruptions, the proficiency level determination unit 5 determines that the user's proficiency level is high in relation to the content that “by saying the words on the button, the user is able to perform its operation” (step S305). When not, the proficiency level determination unit 5 determines that the user's proficiency level is still low in relation to the content (step S306). The section 1 in FIG. 13 represents the section where the user's proficiency level is high. Then, the dialogue control unit 6 receives the user's proficiency level from the proficiency level determination unit 5, and does not deliver the guidance of the content “The operation can be executed by selecting from the words on the buttons” when the user's proficiency level is high (step S307), but delivers the guidance when the user's proficiency level is low (step S308).

In the above embodiment, the number of dialogue control interruption times has been described as an example of the speech content factor. However, the speech content factor is not limited to this. Another example is that in a case where the speech dialogue apparatus is provided with a display function of displaying a menu screen for performing various tasks, the number of times when the user moves the menu hierarchy until the user completes a certain task. In this case, the dialogue control unit 6 suppresses the guidance by merely delivering a message to confirm the content input by the user, when the user's proficiency level in relation to the speech content is high. The dialogue control unit 6 delivers the guidance indicating which menu should be used depending to the purpose, when the user's proficiency level in relation to the speech content is low.

As described heretofore, the speech dialogue apparatus determines the convergence state of the proficiency level determination factor based upon the history stored in the history storage unit 4, determines the user's level of the dialogue behavior based upon the convergence state, and changes the dialogue control based upon the user's proficiency level. Accordingly, it is made possible to eliminate the determination error in the user's proficiency level of the dialogue behavior, as compared to the conventional method of determining the user's proficiency level based upon the user's one-time dialogue behavior. It is possible to perform an appropriate dialogue control according the user's proficiency level correctly determined. Therefore, in the case where the dialogue is conducted well by chance even if the user does not master the speech dialogue apparatus sufficiently, or conversely, in the case where the user is not able to conduct the dialogue even if the user masters the speech dialogue apparatus, the user's proficiency level can be determined correctly. Since an inappropriate dialogue control is not performed, the user is able to communicate with the speech dialogue apparatus smoothly.

Additionally, only the utterance timing may be used for the proficiency level determination factor, another factor except the utterance timing may be used, or only the utterance style, only the speech content factor, or only the pose period may be used. Both of the utterance style and the speech content factor may be used. Alternatively, any combination of combining two or more proficiency level determination factors among the utterance timing, the utterance style, the speech content factor, and the pose period. Furthermore, the proficiency level determination factor may be changed in stages according to the user's proficiency level. For example, the utterance timing is firstly used as the proficiency level determination factor, and the utterance style is used after the user masters the utterance timing, and then the speech content is used after the user masters the utterance style.

### REFERENCE SIGNS LIST

1 input unit
11 utterance start unit
2 speech recognition unit
3 extraction unit
4 history storage unit
5 proficiency level determination unit
6 dialogue control unit

1-7. (canceled)

8. A speech dialogue apparatus for recognizing a speech uttered by a user and for performing a dialogue control, the speech dialogue apparatus comprising:
an input unit for inputting the speech uttered by the user;
an extraction unit for extracting a proficiency level determination factor that is a factor for determining a user's proficiency level in a dialogue behavior, based upon an input result of the speech from the input unit;
a history storage unit for storing a history the proficiency level determination factor extracted by the extraction unit;
a proficiency level determination unit for determining a convergence state of the proficiency level determination factor based upon the history stored in the history storage unit, and for determining the user's proficiency level in the dialogue behavior based upon the convergence state determined; and
a dialogue control unit for changing the dialogue control according to the user's proficiency level determined by the proficiency level determination unit,
wherein the proficiency level determination factor is an utterance timing.

9. A speech dialogue apparatus for recognizing a speech uttered by a user and for performing a dialogue control, the speech dialogue apparatus comprising:
an input unit for inputting the speech uttered by the user;
an extraction unit for extracting a proficiency level determination factor that is a factor for determining a user's proficiency level in a dialogue behavior, based upon an input result of the speech from the input unit;
a history storage unit for storing a history the proficiency level determination factor extracted by the extraction unit;
a proficiency level determination unit for determining a convergence state of the proficiency level determination factor based upon the history stored in the history storage unit, and for determining the user's proficiency level in the dialogue behavior based upon the convergence state determined; and
a dialogue control unit for changing the dialogue control according to the user's proficiency level determined by the proficiency level determination unit,
wherein the proficiency level determination factor includes at least one of a speech style of the user, a speech content factor that is an index of whether or not the user understands a content to be spoken, and a pose period,
wherein the input unit includes an utterance start unit for interrupting the dialogue control being performed when an interruption operation of the dialogue control is detected, and for starting a speech input, and
wherein the speech content factor includes the number of interruption times of interrupting the dialogue control.

10. The audio conversation apparatus according to claim 8 or claim 9, wherein the dialogue control unit enhances the dialogue control in a case where the proficiency level determination unit determines that the user's proficiency level in the dialogue behavior is low, rather than in a case where the proficiency level determination unit determines that the user's proficiency level in the dialogue behavior is high.

11. A dialogue control method for recognizing a speech uttered by a user and for performing a dialogue control by a speech dialogue control apparatus, the dialogue control method comprising the steps of:
inputting the speech uttered by the user;
extracting a proficiency level determination factor that is a factor for determining a user's proficiency level in a dialogue behavior, based upon an input result of the speech in the inputting step;
storing a history the proficiency level determination factor extracted by the extracting step;
determining a convergence state of the proficiency level determination factor based upon the history stored in the storing step and for determining the user's proficiency level in the dialogue behavior based upon the convergence state determined; and
changing the dialogue control according to the user's proficiency level determined in the determining step,
wherein the proficiency level determination factor is an utterance timing.

12. A dialogue control program for causing a computer to execute a process comprising the steps of:
inputting a speech uttered by the user;
extracting a proficiency level determination factor that is a factor for determining a user's proficiency level in a dialogue behavior, based upon an input result of the speech in the inputting step;
storing a history the proficiency level determination factor extracted by the extracting step;
determining a convergence state of the proficiency level determination factor based upon the history stored in the storing step and for determining the user's proficiency level in the dialogue behavior based upon the convergence state determined; and
changing the dialogue control according to the user's proficiency level determined in the determining step,
wherein the proficiency level determination factor is an utterance timing.
